(19) United States
(12) Patent Application Publication
(10) Pub. No.: US 2013/0305524 A1
(43) Pub. Date: Nov. 21, 2013

(54) METHOD AND SYSTEM FOR MANUFACTURING ELECTRIC CELLS FOR ELECTROCHEMICAL ENERGY STORAGE APPARATUS

(71) Applicants: Claus-Rupert Hohenthanner, Hanau (DE); Erhard Schletterer, Ostfildern (DE); Tim Schaefer, Harztor (DE)

(72) Inventors: Claus-Rupert Hohenthanner, Hanau (DE); Erhard Schletterer, Ostfildern (DE); Tim Schaefer, Harztor (DE)

(73) Assignee: Li-Tec Battery GmbH, Kamenz (DE)

(21) Appl. No.: 13/996,295

(22) PCT Filed: Dec. 19, 2011
(86) PCT No.: PCT/EP2011/006412

§ 371 Date: Aug. 12, 2013

(30) Foreign Application Priority Data
Dec. 21, 2010 (DE) 10 2010 055 402.2

(51) Int. Cl. H01M 10/04

(52) U.S. Cl. CPC H01M 10/04
USPC 29/623.2; 29/623.5; 29/731

(57) ABSTRACT

Method for producing electric cells for electrochemical energy storage devices, the method of production comprising the following steps: (S1a) feeding an anode strip, (S1b) feeding a cathode strip (20), (S1c) feeding a separator strip (30), preferably two separator strips, (S3a) stamping out an anode element from the anode strip, (S3b) stamping out a cathode element from the cathode strip (20), (S5) cutting the separator strip (30), preferably the two separator strips, into separator elements, (S6a) applying an anode element to a first separator element to form an anode-separator element, (S6b) applying a cathode element to a second separator element to form a cathode-separator element, and (S7) stacking an anode number of anode-separator elements and a cathode number of cathode-separator elements to form an anode-separator-and-cathode-separator stack.

The present invention hereby incorporates by reference the content of the DE 10 055 402.2 priority application in its entirety.

The present invention relates to a method and system for manufacturing electric cells for electrochemical energy storage apparatus which can for example be used in an electrically powered motor vehicle and in particular relates to a continuous manufacturing method and a continuous manufacturing system in an uninterrupted production line.

Widespread use in electrically operated motor vehicles necessitates a high number of electric cells of a more economical manufacturing.

The present invention is thus based on the object of improving the manufacturing method and manufacturing system for electric cells.

In the terms of the invention, an electric cell is to be understood as an apparatus which also serves in storing chemical energy and releasing electrical energy. The electric cell comprises an electrode stack having at least one anode, one cathode and one separator provided to absorb the electrolyte.

With respect to the method, this object is accomplished by an manufacturing method for electric cells for electrochemical energy store apparatus comprising the steps of supplying an anode strip, supplying a cathode strip, supplying a separator strip, preferably two separator strips, stamping out an anode element from the anode strip, stamping out a cathode element from the cathode strip, cutting the separator strip, preferably the two separator strips, into separator elements, depositing an anode element onto a first separator element to form an anode/separator element, depositing a cathode element onto a second separator element to form a cathode/separator element and stacking an anode number of anode/separator elements and a cathode number of cathode/separator elements to form an anode/separator/cathode/separator stack. Doing so achieves continuous and uninterrupted manufacturing of the electric cells.

The manufacturing method preferentially comprises the steps of drying the anode strip, drying the cathode strip and drying the separator strip, whereby the quality of the anode/separator element and the cathode/separator element can be improved.

After an anode element has been stamped out from the anode strip and after a cathode element has been stamped out from the cathode strip, it is particularly preferential for the manufacturing method to comprise the steps of cleaning the anode element and cleaning the cathode element. This thus eliminates any impurities there may be from the stamping steps.

It has proven advantageous in the manufacturing method for the number of anodes to be equal to the number of cathodes. In conjunction hereto, it has shown to be particularly advantageous for the number of anodes and the number of cathodes to be selected from between the range of 20-50. 30 has proven to be a particularly advantageous number of anodes and cathodes.

The manufacturing method can furthermore comprise the steps of detecting the given parameter values of the anode/separator/cathode/separator stack, comparing the detected parameter values to a predefined parameter value range and sorting out the anode/separator/cathode/separator stack should the parameter values detected be outside the predefined parameter range. Doing so enables meeting the requirements of removing inadequate anode/separator/cathode/separator stacks from the manufacturing system at an early stage and thereby avoiding the additional costs which would arise upon later sorting out.

The manufacturing method can additionally comprise the step of fixing the anode/separator/cathode/separator stack. The manufacturing method can moreover comprise a step of cutting the anode elements and the cathode elements into electrodes. The manufacturing method can further comprise the step of supplying the anode/separator/cathode/separator stack with a conductor and affixing the conductor to the anode/separator/cathode/separator stack.

The manufacturing method step of affixing the conductor to the anode/separator/cathode/separator stack can additionally comprise the further step of welding the conductor to the anode/separator/cathode/separator stack and masking the conductor on the anode/separator/cathode/separator stack, whereby the quality of the subsequent sealing can be increased.

The manufacturing method can furthermore comprise the steps of inserting the anode/separator/cathode/separator stack into a jacket and sealing the jacket while leaving open an electrolyte inlet. The manufacturing method can in addition comprise the step of filling the anode/separator/cathode/separator stack with an electrolyte via the electrolyte inlet.

The manufacturing method can moreover comprise the steps of detecting the given intermediate parameter values of the sealed jacket containing the anode/separator/cathode/separator stack, comparing the detected intermediate parameter values to a predefined range of intermediate parameter values, and sorting out the sealed jacket with anode/separator/cathode/separator stack should the intermediate parameter values detected be outside of the predefined parameter range. Doing so enables meeting the requirements of removing inadequate sealed jackets with anode/separator/cathode/separator stacks from the manufacturing system at an early stage and thereby avoiding the additional costs which would arise upon later sorting out.

The manufacturing method can additionally comprise the steps of end-sealing the jacket in an electric cell and inscribing the electric cell.

With respect to the system, the object is accomplished by a manufacturing system for electric cells comprising a feeder apparatus having an anode reel for an anode strip, a cathode reel for a cathode strip, a separator reel for a separator strip, preferably two separator reels for two separator strips, a stamping apparatus designed to stamp an anode element out of the anode strip and to stamp a cathode element out of the cathode strip, a cutting apparatus designed to cut the separator strip, preferably designed to cut two separator strips, into separator elements, an applicator apparatus designed to deposit an anode element onto a first separator element to form an anode/separator element and designed to deposit a cathode element onto a second separator element to form a cathode/separator element, and a stacking apparatus designed to stack an anode number of anode/separator elements and a cathode number of cathode/separator elements into an anode/separator/cathode/separator stack.

The manufacturing system can in addition comprise at least one further apparatus selected from among a group of: a drying apparatus designed to dry the anode strip, to dry the cathode strip and to dry the separator strip, a cleaning apparatus designed to clean the anode element and to clean the cathode element, a sorting apparatus comprising a detection unit designed to detect the given parameter values of the anode/separator/cathode/separator stack, a comparator unit designed to compare the detected values of the given parameters to a predefined parameter value range and a sorting unit designed to sort out the anode/separator/cathode/separator stack when the given parameter values detected are outside of the predefined parameter range, a fixing apparatus designed to fix the anode/separator/cathode/separator stack, a cutting apparatus designed to cut the anode elements and the cathode elements into electrodes, a conductor fastening apparatus comprising a feeder unit designed to feed a conductor to the anode/separator/cathode/separator stack, an applicator unit designed to affix the conductor to the anode/separator/cathode/separator stack, a welding unit designed to weld the conductor to the anode/separator/cathode/separator stack and a masking unit designed to mask the conductor on the anode/separator/cathode/separator stack, a casing apparatus comprising an inserting unit designed to insert the anode/separator/cathode/separator stack into a jacket and a sealing unit designed to seal the jacket while leaving open an electrolyte inlet, a filling apparatus designed to fill the anode/separator/cathode/separator stack with an electrolyte via the electrolyte inlet, an end apparatus comprising an end-sealing unit designed to end-seal the jacket containing the anode/separator/cathode/separator stack into an electric cell and an inscribing unit designed to inscribe the electric cell, an intermediate sorting apparatus comprising an intermediate detection unit designed to detect the given intermediate parameter values of the sealed jacket with the anode/separator/cathode/separator stack, an intermediate comparator unit designed to compare the given intermediate parameter values detected to a predefined intermediate parameter value range and an intermediate sorting unit designed to sort out the sealed jacket with anode/separator/cathode/separator stack when the given intermediate parameter values detected are outside of the predefined intermediate parameter range, a dry air processing apparatus designed to supply treated dry air to the above-cited apparatus and the above-cited units with the exception of the feeder apparatus and the drying apparatus via dry air supply lines, an end sorting apparatus having a detection unit designed to detect the given end parameter values of the electric cell, an end comparator unit designed to compare the given end parameter values detected to a predefined end parameter value range and an end sorting unit designed to sort out the electric cell when the given end parameter values detected are outside of the predefined end parameter range.

The present invention also relates to an electric cell for an electrochemical energy storage apparatus manufactured in accordance with one of the above-cited manufacturing methods or by means of the above-cited manufacturing system.

Further advantages, features and possible applications of the present invention ensue from the following description in conjunction with the figures, which show:

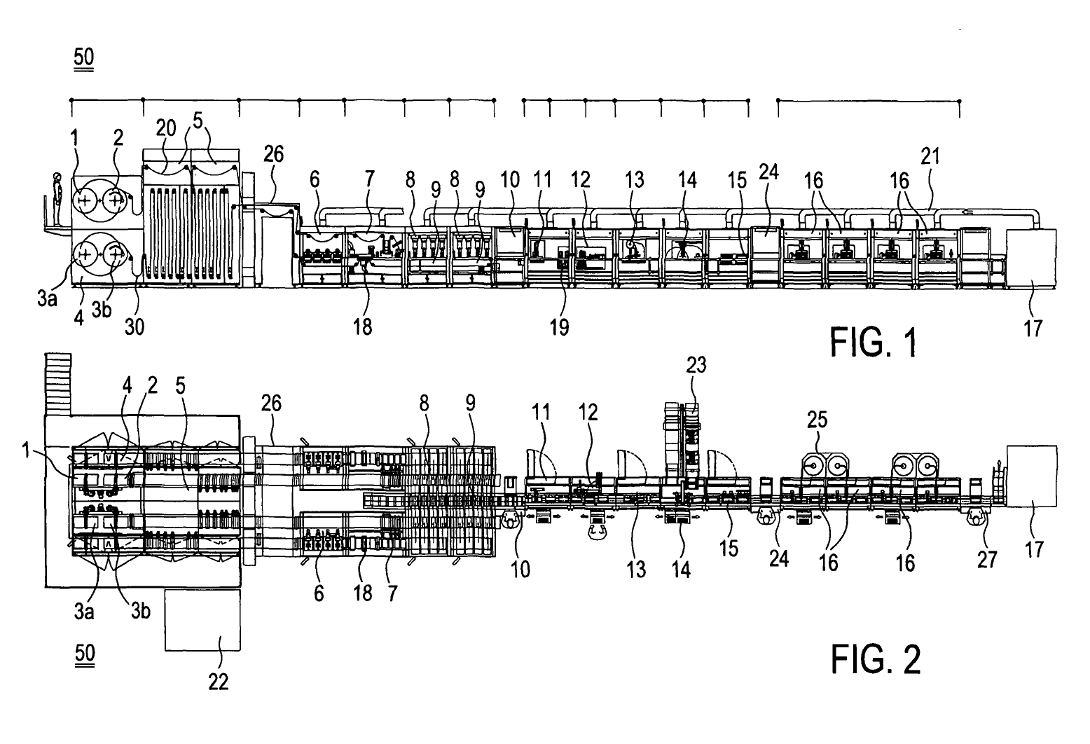

FIG. 1 a cross-sectional depiction of an inventive manufacturing system for electric cells,

FIG. 2 a schematic plan view of the manufacturing system shown in FIG. 1,

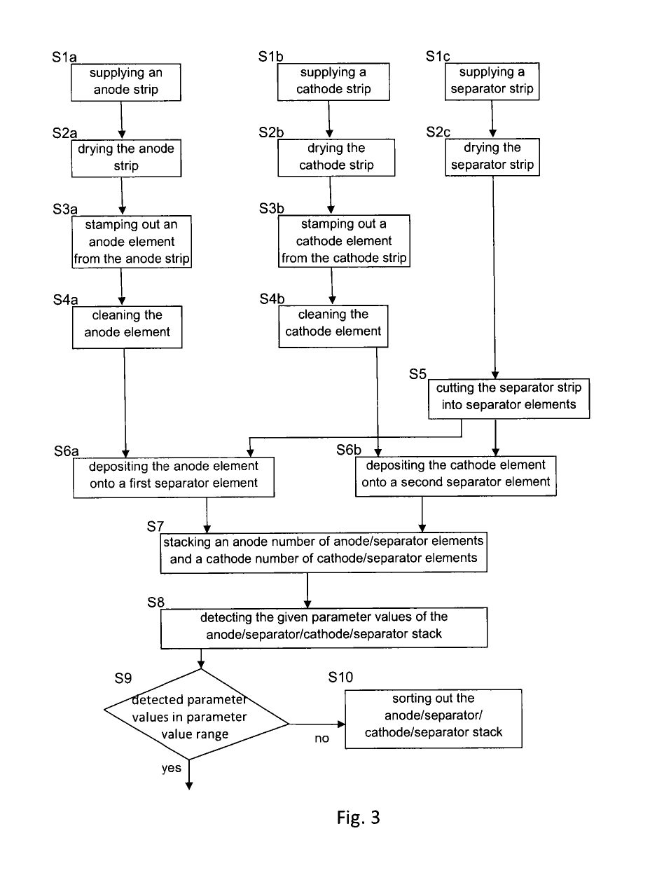

FIG. 3 a first section of a flow chart for an inventive manufacturing method,

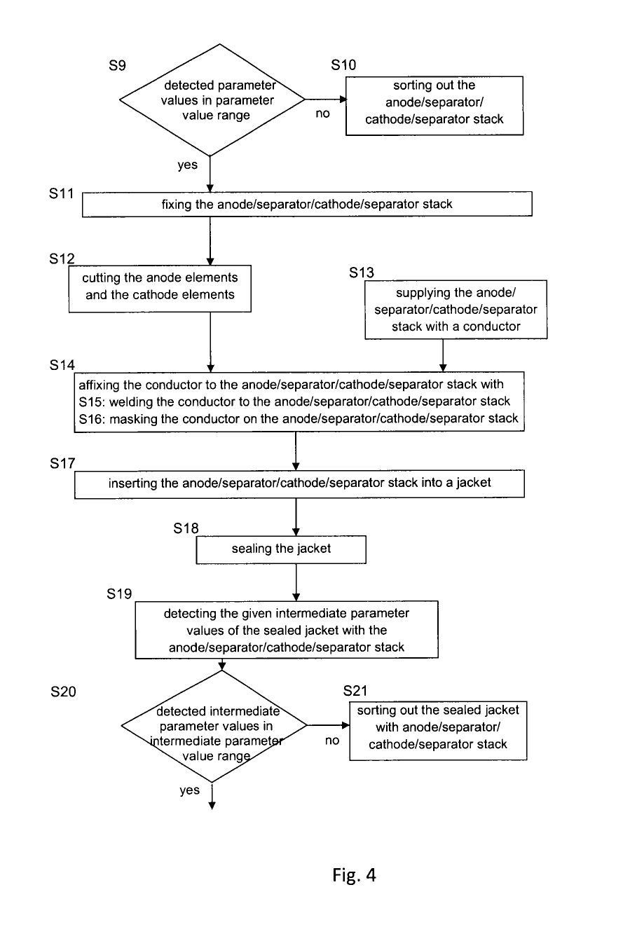

FIG. 4 a second section of the flow chart for the manufacturing method, and

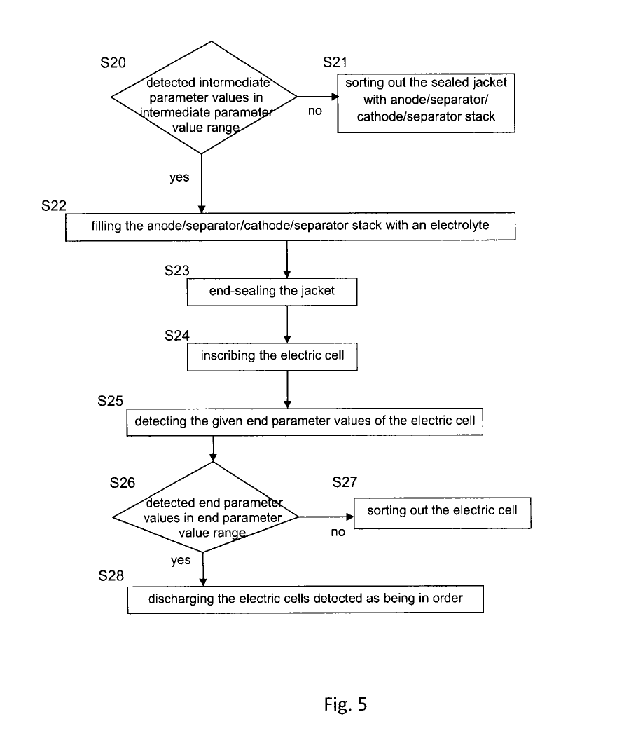

FIG. 5 a third section of the flow chart for the manufacturing method.

FIG. 1 shows a schematic cross-sectional depiction of a manufacturing system 50 according to the present invention and FIG. 2 shows a schematic plan view of the manufacturing system 50. An anode reel 1 for an anode strip, a cathode reel 2 for a cathode strip 20 as well as two separator reels 3a and 3b for separator strips 30 are arranged in a feeder apparatus 4. The anode strip, the cathode strip 20 and the separator strips 30 are guided within a drying apparatus 5 to which a separate dry air processing and cooling apparatus 22 is connected.

The anode strip, the cathode strip 20 and the separator strips 30 are guided over a transit apparatus 26 to a stamping apparatus 6 which is connected to a dry air processing apparatus 17 via a dry air supply line 21. Anode elements are stamped out of the anode strip and cathode elements stamped out of the cathode strip 20 by the stamping apparatus 6. Conveyor belts feed the anode elements and the cathode elements to a cleaning apparatus 18 designed to clean the anode elements and cathode elements. The separator strips 30 are fed to a cutting apparatus 7 designed to cut the separator strips 30 into separator elements. The cutting can be realized by laser units, for example. The cleaning apparatus 18 and the cutting apparatus 7 are also connected to the dry air processing apparatus 17 via the dry air supply line 21.

The cleaned anode elements and cathode elements and the cut separator elements are fed to an applicator apparatus 8 which is designed to deposit the anode elements and the cathode elements onto the separator elements in order to form anode/separator elements and cathode/separator elements. A stacking apparatus 9 stacks the anode/separator elements and the cathode/separator elements into an anode/separator/cathode/separator stack.

A detection unit in a sorting apparatus 10 detects given parameter values of the anode/separator/cathode/separator stack, e.g. by means of a camera. These given parameter values detected are compared to a predefined parameter range in a comparator unit and those anode/separator/cathode/separator stacks having detected parameter values which are outside the predefined parameter range are sorted out of the production line by a sorting unit.

A fixing apparatus 11 fixes the anode/separator/cathode/separator stacks found to be in order and the anode elements and the cathode elements are cut to size as electrodes in an electrode cutting apparatus 19. The fixing apparatus 11 and the electrode cutting apparatus 19 are also connected to the dry air processing apparatus 17 via the dry air supply line 21.

Conductors are fed to the fixed anode/separator/cathode/separator stacks by a conductor feeder unit in a conductor fastening apparatus 12 and the conductors are deposited on the fixed anode/separator/cathode/separator stacks by an applicator unit, wherein the applicator unit comprises a welding unit 13 to weld a conductor to an anode/separator/cathode/separator stack and a masking unit to mask the welded conductor. The conductor fastening apparatus 12 and the welding unit 13 are also connected to the dry air processing apparatus 17 via the dry air supply line 21.

The anode/separator/cathode/separator stacks with the affixed conductors are fed to a casing apparatus which comprises an inserting unit 14 to insert said anode/separator/cathode/separator stacks into jackets and a sealing unit 15 to seal the jackets while leaving open an electrolyte inlet. The inserting unit 14 and the sealing unit 15 are also connected to the dry air processing apparatus 17 via the dry air supply line 21.

Given intermediate parameter values for the sealed jackets with the anode/separator/cathode/separator stacks are detected by an intermediate detection unit in an intermediate sorting apparatus 25. These given intermediate parameter values detected are compared to a predefined intermediate parameter range in an intermediate comparator unit and those sealed jackets with anode/separator/cathode/separator stacks having detected intermediate parameter values which are outside of the predefined intermediate parameter range are sorted out of the production line by an intermediate sorting unit.

The encased anode/separator/cathode/separator stacks found to be in order are filled with an electrolyte via the electrolyte inlet in a filling apparatus 16, wherein the electrolyte supply can be located in electrolyte storage containers 25 outside of the drying area, whereas the filling apparatus 16 is connected to the dry air processing apparatus 17 via the dry air supply line 21.

The jackets of the filled anode/separator/cathode/separator stacks are end-sealed into electric cells by means of an end-sealing unit and inscribed with an inscribing unit in an end apparatus, wherein the end apparatus is connected to the dry air processing apparatus 17 via the dry air supply line 21.

Given end parameter values for the electric cells are detected in an end sorting apparatus 27. These given end parameter values detected are compared to a predefined end parameter range in an end comparator unit and those electric cells having detected end parameter values outside of the predefined end parameter range are sorted out by an end sorting unit.

FIGS. 3 to 5 show a flow chart of the electric cell manufacturing method according to the present invention. It can be recognized from FIG. 3 that an anode strip, a cathode strip and a separator strip, preferably two separator strips, are supplied in the respective S1a, S1b and S1c steps, and the anode strip, cathode strip and separator strips are dried in the respective S2a, S2b and S2c steps. Thereafter, the anode elements are stamped out of the anode strip and the cathode elements are stamped out of the cathode strip in the respective S3a and S3b steps. The stamped-out anode elements and cathode elements are then cleaned in the respective S4a and S4b steps and separator elements are cut out of the separator strips in step S5.

In the respective subsequent steps S6a and S6b, the cleaned anode elements are deposited onto the first separator elements to form anode/separator elements and the cleaned cathode elements are deposited onto the second separator elements to form cathode/separator elements. In step S7 which then follows, the anode/separator elements and the cathode/separator elements are stacked into anode/separator/cathode/separator stacks.

The given parameter values of the anode/separator/cathode/separator stacks are detected in step S8 and the given parameter values detected are compared to a predefined range of parameters in step S9. Should the values detected for the given parameters lie outside of the predefined parameter range, the anode/separator/cathode/separator stacks found not to be in order are sorted out in step S10.

It can be seen from FIG. 4 that the manufacturing method will otherwise continue with step S11, in which the anode/separator/cathode/separator stack is fixed. The anode elements and the cathode elements of the anode/separator/cathode/separator stack are then subsequently cut to size as electrodes in step S12.

In step S13, conductors are supplied to the anode/separator/cathode/separator stacks on the production line. Thereafter in step S14, the conductors are deposited on the anode/separator/cathode/separator stacks, wherein step S14 comprises step S15 of welding the conductor to an anode/separator/cathode/separator stack and step S16 of masking the conductor on the anode/separator/cathode/separator stack. In step S17, the anode/separator/cathode/separator stacks with conductors are inserted into jackets which are then sealed in step S18.

In step S19, given intermediate parameter values are detected for the sealed jackets containing the anode/separator/cathode/separator stacks and in step S20, the given intermediate parameter values detected are compared to a predefined range of intermediate parameters. Should the values detected for the given intermediate parameters lie outside of the predefined intermediate parameter range, the sealed jackets with anode/separator/cathode/separator stacks found not to be in order are sorted out in step S21.

It can be seen from FIG. 5 that the manufacturing method will otherwise continue with step S22, in which the anode/separator/cathode/separator stacks are filled with an electrolyte, followed by being end-sealed into electric cells in step S23. The electric cells are then subsequently inscribed in step S24.

In step S25, given end parameter values for the electric cells are detected and in step S26, the given end parameter values detected are compared to a predefined range of end parameters. Should the values detected for the given end parameters lie outside of the predefined end parameter range, the electric cells found not to be in order are sorted out in step S27. Otherwise, the electric cells found to be in order are discharged in step S28.

### LIST OF REFERENCE NUMERALS

1 anode reel
2 cathode reel
3a, 3b separator reel
4 feeder apparatus
5 drying apparatus
6 stamping apparatus
7 cutting apparatus
8 applicator apparatus
9 stacking apparatus
10 sorting apparatus
11 fixing apparatus
12 conductor fastening apparatus
13 welding unit
14 inserting unit
15 sealing unit
16 filling apparatus
17 dry air processing apparatus
18 cleaning apparatus
19 electrode cutting apparatus
20 cathode strip
21 dry air supply line
22 dry air processing and cooling apparatus
23 casing feeder apparatus
24 intermediate sorting apparatus
25 electrolyte storage container
26 transit apparatus
27 end sorting apparatus
50 manufacturing system
S1a supplying an anode strip
S1b supplying a cathode strip
S1c supplying a separator strip
S2a drying the anode strip
S2b drying the cathode strip
S2c drying the separator strip
S3a stamping out an anode element
S3b stamping out a cathode element
S4a cleaning the anode element
S4b cleaning the cathode element
S5 cutting the separator strip into separator elements
S6a depositing an anode element onto a first separator element
S6b depositing a cathode element onto a second separator element
S7 stacking an anode number of anode/separator elements and a cathode number of cathode/separator elements
S8 detecting the given parameter values of the anode/separator/cathode/separator stack
S9 comparing the detected parameter values to a predefined parameter value range
S10 sorting out the anode/separator/cathode/separator stack when the detected parameter values lie outside of the predefined range of parameter values
S11 fixing the anode/separator/cathode/separator stack
S12 cutting the anode elements and the cathode elements
S13 supplying the anode/separator/cathode/separator stack with a conductor
S14 affixing the conductor to the anode/separator/cathode/separator stack
S15 welding the conductor to the anode/separator/cathode/separator stack
S16 masking the conductor on the anode/separator/cathode/separator stack
S17 inserting the anode/separator/cathode/separator stack into a jacket
S18 sealing the jacket
S19 detecting the given intermediate parameter values of the sealed jacket containing the anode/separator/cathode/separator stack
S20 comparing the detected intermediate parameter values to a predefined range of intermediate parameter values
S21 sorting out the sealed jacket with anode/separator/cathode/separator stack when the detected intermediate parameter values lie outside of the predefined intermediate parameter value range
S22 filling the anode/separator/cathode/separator stack with an electrolyte
S23 end-sealing the jacket
S24 inscribing the electric cell
S25 detecting the given end parameter values of the electric cell
S26 comparing the detected end parameter values to a predefined range of end parameter values
S27 sorting out the electric cell when the detected end parameter values lie outside of the predefined end parameter value range
S28 discharging the electric cells detected as being in order

1. A method for manufacturing electric cells for electrochemical energy storage apparatus, comprising:
supplying an anode strip;
supplying an cathode strip;
supplying at least one separator strip;
drying the anode strip;
drying the cathode strip;
drying the at least one separator strip;
stamping an anode element out of the anode strip;
stamping a cathode element out of the cathode strip;
cutting the at least one separator strip into separator elements;
depositing an anode element onto a first separator element to form an anode/separator element;
depositing a cathode element onto a second separator element to form an cathode/separator element; and
stacking an anode number of anode/separator elements and a cathode number of cathode/separator elements to form an anode/separator/cathode/separator stack.

2. (canceled)

3. The electric cell manufacturing method according to claim 1, further comprising:
cleaning the anode element; and
cleaning the cathode element
Subsequent to the stamping of the anode element and stamping of the cathode element.

4. The electric cell manufacturing method according to claim 1, wherein the number of anodes is equal to the number of cathodes.

5. The electric cell manufacturing method according to claim 4, wherein the number of anodes and the number of cathodes is between 20 to 50.

6. The electric cell manufacturing method according claim 1, further comprising:
detecting given parameter values of the anode/separator/cathode/separator stack;
comparing the parameter values detected to a predefined range of parameter values; and
sorting out the anode/separator/cathode/separator stack when the parameter values detected lie outside of the predefined range of parameter values.

7. The electric cell manufacturing method according to claim 1, further comprising:
fixing the anode/separator/cathode/separator stack.

8. The electric cell manufacturing method according to claim 1, further comprising:
cutting the anode elements and the cathode elements into electrodes.

9. The electric cell manufacturing method according to claim 1, further comprising:
supplying the anode/separator/cathode/separator stack with a conductors; and
affixing the conductor to the anode/separator/cathode/separator stack.

10. The electric cell manufacturing method according to claim 9, wherein affixing the conductor further comprises:
welding the conductor to the anode/separator/cathode/separator stack, and
masking the conductor on the anode/separator/cathode/separator stack.

11. The electric cell manufacturing method according to claim 10, further comprising:
inserting the anode/separator/cathode/separator stack into a jacket; and
sealing the jacket while leaving open an electrolyte inlet.

12. The electric cell manufacturing method according to claim 11, further comprising:
filling the anode/separator/cathode/separator stack with an electrolyte via the electrolyte inlet.

13. The electric cell manufacturing method according to claim 12, further comprising:
end-sealing the jacket; and
inscribing the electric cell.

14. A system for manufacturing electric cells according to a manufacturing method in accordance with claim 1 comprising:
a feeder apparatus having an anode reel for an anode strip, a cathode reel for a cathode strip, a separator reel for a separator strip;
a drying apparatus configured to dry the anode strip, to dry the cathode strip and to dry the separator strip;
a stamping apparatus configured to stamp an anode element out of the anode strip and to stamp a cathode element out of the cathode strip;
a cutting apparatus configured to cut the separator strip into separator elements;
an applicator apparatus configured to deposit an anode element onto a first separator element to form an anode/separator element and to deposit a cathode element onto a second separator element to form a cathode/separator element; and
a stacking apparatus configured to stack an anode number of anode/separator elements and a cathode number of cathode/separator elements into an anode/separator/cathode/separator stack.

15. The system for manufacturing electric cells according to claim 14, further comprising at least one of:
a cleaning apparatus configured to clean the anode element and to clean the cathode element;
a sorting apparatus including a detection unit configured to detect given parameter values of the
anode/separator/cathode/separator stack, a comparator unit configured to compare the detected parameter values to a predefined parameter value range and a sorting unit configured to sort out the
anode/separator/cathode/separator stack when the detected parameter values are outside of the predefined range of parameters;
a fixing apparatus configured to fix the anode/separator/cathode/separator stack;
an electrode cutting apparatus configured to cut the anode elements and the cathode elements into electrodes;
a conductor fastening apparatus including a feeder unit configured to feed a conductor to the anode/separator/cathode/separator stack, an applicator unit configured to affix the conductor to the anode/separator/cathode/separator stack, a welding unit configured to weld the conductor to the anode/separator/cathode/separator stack and a masking unit designed to mask the conductor on the
anode/separator/cathode/separator stack;
a casing apparatus including an inserting unit configured to insert the anode/separator/cathode/separator stack into a jacket and a sealing unit configured to seal the jacket while leaving open an electrolyte inlet;
a filling apparatus configured to fill the anode/separator/cathode/separator stack with an electrolyte via the electrolyte inlet;
an intermediate sorting apparatus including an intermediate detection unit configured to detect given intermediate parameter values of the sealed jacket with the anode/separator/cathode/separator stack, an intermediate comparator unit configured to compare the detected intermediate parameter values to a predefined intermediate parameter value range and an intermediate sorting unit configured to sort out the sealed jacket with anode/separator/cathode/separator stack when the intermediate parameter values detected are outside of the predefined intermediate parameter range;
an end apparatus including an end-sealing unit configured to end-seal the jacket into an electric cell and an inscribing unit designed to inscribe the electric cell;
a dry air processing apparatus configured to supply treated dry air to at least one of the above-cited apparatus and the above-cited units with the exception of the feeder apparatus and the drying apparatus via dry air supply lines;
an end sorting apparatus including a detection unit configured to detect given end parameter values of the electric cell, an end comparator unit configured to compare the detected end parameter values to a predefined end parameter value range and an end sorting unit configured to sort out the electric cell when the end parameter values detected are outside of the predefined end parameter range.
